(19) United States
(12) Patent Application Publication
(10) Pub. No.: US 2008/0053612 A1
(43) Pub. Date: Mar. 6, 2008

(54) Method and Apparatus for Heating Plastics Regions of an Open End Zone of a Carton Sleeve

(75) Inventor: Erik Rogeberg, Drammen (NO)

Correspondence Address: CALFEE HALTER & GRISWOLD, LLP, 800 SUPERIOR AVENUE, SUITE 1400, CLEVELAND, OH, 44114, US

(73) Assignee: Elopak Systems AG

(21) Appl. No.: 11/597,147

(22) PCT Filed: May 25, 2005
(86) PCT No.: PCT/IB05/01432

§ 371 Date: Apr. 9, 2007

(30) Foreign Application Priority Data
May 26, 2004 (GB) 0411721.4

(51) Int. Cl. C09J 5/02; B29C 65/10

(52) U.S. Cl. 156/324.4; 156/359; 156/499

(57) ABSTRACT

An apparatus for heating plastics surface regions of an open end zone of a carton sleeve prior to sealing of the end zone includes a heater head which has a side wall (102) and is closed at its distal end by a wall (106) and is open at its proximal end to receive hot air to flow out sideways via holes (108). The hot air is supplied to the heater head in two separate streams (110) and (112) through two separate ducts (118) and (120). The ducts have their own air-heating arrangements (122) and (124) which can be controlled, insofar as temperature is concerned, to at least some extent independently of each other. The ducts (118) and (120) contain respective air blowers (126) and (128) the speeds of which are adjustable relative to each other. It is thereby possible to adjust the temperature and/or flow rates of the air streams (110) and (112). The streams (110) and (112) enter respective separate compartments (114) and (116) of the heater head which are formed by a partition (130), the compartment (114) occupying most of the interior and the compartment (116) occupying that corner of the interior at which a longitudinal lap seal of the open end zone of the carton sleeve is present. In this manner, the internal plastics surface region at the relevant part of the longitudinal lap seal can be subjected to a level of heating which ensures blocking of channel leakages thereat, whilst the other sealing regions of the end closure are subjected to a lower temperature, sufficient to render them tacky, but such as to minimise the production of heat cracks and of off-taste.

This invention relates to a method of and apparatus for heating plastics surface regions of an open end zone of a sheet material tube prior to sealing of the end zone.

For form-fill-seal packaging machines which are supplied with carton blanks converted from sheet material webs comprised of a plastics-coated substrate of cellulosic material, it is known, in the converting plant, to fold each blank into a tube whilst forming a longitudinal lap seal between a so-called fifth panel and a so-called first panel. The longitudinal lap seal may be produced by rendering tacky an external plastics surface of the fifth panel (and possibly also a corresponding strip of the internal plastics surface of the first panel), often by flame sealing activation, and then applying that tacky external plastics surface to the internal plastics surface of the first panel. Owing to variations in the flame sealing activation, the quality of the lap seal may vary along its length. The flat tubes so produced, called carton blanks, are then supplied to a form-fill-seal packaging machine in which the flat tube is opened into a rectangular tube, called a carton sleeve, and in which, usually while the sleeve is received on an indexing mandrel and at a bottom heating station, a heater head (also called a heater centre) is displaced to immediately adjacent to sub-panels which will become the bottom end closure of the filled and sealed carton, the displacement possibly being performed after pre-breaking of the bottom end closure sub-panels. Hot air is then supplied to the heater head which is provided with a pattern of holes, especially in side walls thereof, through which jets of the hot air are distributed onto internal surface regions of the internal plastics coating of the open bottom end zone (and possibly also onto external surface regions of the external plastics coating of that open end zone) to render those regions tacky, whereafter the bottom end closure sub-panels are folded over and the tacky regions sealed together to form the bottom end closure. Afterwards, the bottom-closed, open-top carton is stripped from the mandrel and, possibly after pre-breaking of top end closure sub-panels, filled and then forwarded to a top heating station. At that station, a heater head similar to that described above is displaced to adjacent to end closure sub-panels of the open top end zone of the carton and the jets of hot air render tacky internal surface regions of the internal plastics coating of the top end zone (and possibly also external surface regions of the external plastics coating of that zone). The carton is then advanced to one or more stations where the top end closure sub-panels are folded and sealed together, to form a top end closure, so that there is provided a filled and sealed, gable-top, slant-top or flat-top carton. The aforementioned variations in quality of the lap seal can be particularly disadvantageous where poor quality exists in the lap seal at the bottom end zone and/or the top end zone, since these are the locations where the lap seal is especially stressed during pre-breaking, folding and sealing of the bottom and top end closure sub-panels. Furthermore, a considerable amount of time may need to be spent by the packaging machine operator in running tubular blanks to try to arrive at an optimum result in the narrow final temperature range permissible and, moreover, a significant wastage of blanks occurs until the optimum has been obtained. Such waste of time and blanks is also commonplace when there is a change from supplying to the packaging machine tubular blanks of one particular character to tubular blanks of even an only slightly different character.

For each heater head, the hot air stream supplied to the heater head from a hot air source is at substantially the same temperature, and at substantially the same flow rate, throughout its cross-section, so that the hot air jets from the heater head are all at substantially the same temperature, and at roughly the same flow rate, as each other. Both of these parameters influence the final temperature of the surface regions to be sealed. There is a relatively narrow range of final temperature which is permissible, since, on the one hand, the temperature and the flow rate of the hot air should be sufficiently high to soften the plastics coating zones at the double-thickness longitudinal lap seal to close any potential leakage paths in the lap seal at the end closure, so as to prevent leakage of ambient air into the carton and, of course, to prevent leakage of product from the carton; but not high enough to produce heat cracks in the single-thickness sheet material over the other surface regions to be sealed, nor high enough to produce any significant off-taste through excessive heating of at least those other surface regions. On the other hand, the final temperature should not be so low that heat cracks and off-taste are avoided but lap seal channel leakages may occur. However, in even that narrow range of final temperature, avoiding of noticeable off-taste is particularly difficult where the product to be packaged, for example, water, does not itself have any noticeable taste. Packaging of such products can often result in claims against the supplier of the carton blanks.

Among such known heater head nozzle arrangements are those disclosed in EP-A-537,962 for top heating and EP-A-832,731 and EP-A-938,965 for bottom heating.

In the heater head nozzle arrangement of EP-A-537,962 there are an inner heater box and two outer heater boxes each of which is formed with a particular pattern of holes to heat selected portions of the carton sleeve top and avoid heating other portions thereof. A special feature of the hole pattern of one of the outer boxes is that a folded pouring spout sub-panel is secured by a bond made in a central folded corner of its outside surface, bonds between outer corners of its outside surface, and bonds between outer corners of its inside surface and confronting surfaces of other sealing sub-panels. To facilitate opening of the pouring spout whilst providing an hermetic seal, areas on those confronting surfaces are not directly heated.

In the heater head nozzle arrangement of EP-A-832,731 there are a primary heater and a secondary heater arranged respectively at first and second stop stations of bottom-forming radial mandrels. The primary and secondary heaters have primary and secondary hot air nozzles. The primary hot air nozzle is fixedly provided on a phantom outward extension line of the mandrel as halted in the first stop station, so as not to interfere with the end portion of the carton sleeve fitted around the halted mandrel and has holes directed toward local parts of the inside surfaces of certain of the bottom end closure sub-panels, including particularly the corresponding part of the longitudinal lap seal. The secondary hot air nozzle is movable on a phantom outward extension line of the mandrel as halted in the second stop station so as to advance into and retract from the bottom end of the carton sleeve as halted in the second stop station, and has holes directed toward large selected areas of the inside and outside surfaces of the bottom closure panels when the secondary hot air nozzle advances.

In the nozzle arrangement of EP-A-938,965, there are again two nozzles at respective mandrel stations, the two nozzles being of the same construction as each other. Each nozzle is advanceable to receive the bottom end closure panels of the carton sleeve. The nozzle has holes directed towards selected areas of the surfaces of the end closure sub-panels. Among the holes of the nozzle, those directed toward the region further from the bottom extremity of the carton sleeve have a greater open area ratio than those directed toward the region proximate to the bottom extremity.

According to a first aspect of the present invention, there is provided a method comprising providing a sheet material tube having plastics surface regions which are to be sealed together and are distributed around an open end zone of the tube, heating with a heating medium said plastics surface regions so as to render said regions tacky, the heating being performed in such manner that one surface region of said surface regions is heated to a level higher than are at least some of the others of said regions, and pressing said regions together and thereby sealing said end zone, the temperature of the heating medium impinging on said one surface region being higher than that of the heating medium impinging on said at least some of the others of said regions.

According to a second aspect of the present invention, there is provided apparatus for operating upon a sheet material tube having plastics surface regions which are to be sealed together and are distributed around an open end zone of the tube, comprising a heating device so arranged as to emit both a higher-temperature flow of heating medium to impinge upon one surface region of said surface regions and a lower-temperature flow of heating medium to impinge upon at least some of the others of said regions, so that the heating medium heats and thereby renders said regions tacky and said one surface region is heated to a level higher than are said at least some of the others of said regions.

According to a third aspect of the present invention, there is provided apparatus for operating upon a sheet material tube having plastics surface regions which are to be sealed together and are distributed around an open end zone of the tube, comprising a heating device comprised of a heater head formed with a plurality of holes through a wall of said head, said wall bounding the interior of said head, said head having at least one inlet for heating medium which passes from said interior through said holes to heat and thereby render said regions tacky, and said interior having therein a partition which serves to separate heating medium flowing to some of said holes from heating medium flowing to others of said holes, whereby one surface region of said surface regions can be heated to a level higher than are at least some of the others of said regions.

Owing to the present invention, because the heating of the one surface region (in particular at a longitudinal lap seal of the tube) and the heating of at least some of the other surface regions to be sealed together to form the end closure can be significantly independent of each other, the problems which arise through needing a narrow final temperature range permissible for rendering tacky all of the sealing regions of the end closure can be avoided.

The end zone of the sheet material tube may be the bottom end zone or top end zone of a carton sleeve from which for example a gable-top carton, a slant-top carton or a flat-top carton are to be formed and the tube may already have a closed opposite end.

The heating medium may be, for example, infrared radiation, but is preferably a hot gaseous substance, for example hot air.

The sheet material of the tube may be a plastics-coated substrate, particularly of cellulosic material, for example paperboard. The sheet material may have not only an internal plastics coating but also an external plastics coating. The plastics surface regions may all be internal plastics surface regions of the end zone.

Where the heating medium is a hot gaseous substance, the gaseous substance used for heating the plastics surface region at the lap seal is preferably supplied as a stream separate from the stream of hot gaseous substance for heating at least some of the other plastics surface regions to be sealed. However, it is possible instead to utilise a single stream of hot gaseous substance with one cross-sectional part of the stream to be used to heat the lap seal region being of a higher temperature and/or flow rate than the other parts of the cross-section of the stream. Heating of the lap seal region to a higher level than the other regions is achieved by the hot gaseous substance supplied to the lap seal region being at a higher temperature and/or higher flow rate than the hot gaseous substance supplied to at least some of the other regions.

In order that the invention may be clearly and completely disclosed, reference will now be made, by way of example, to the accompanying drawings, in which:

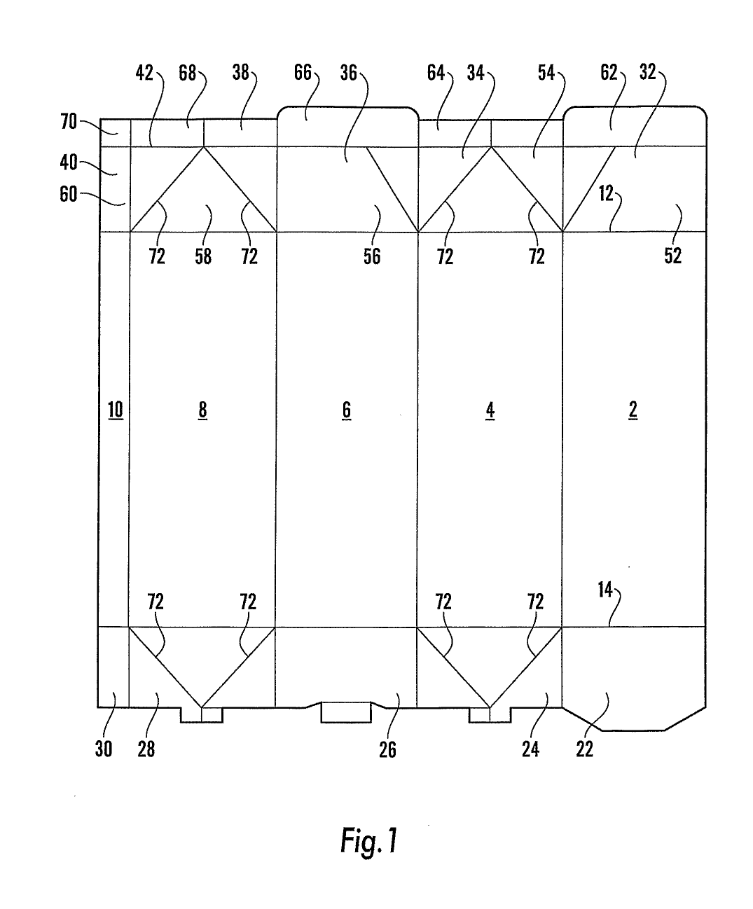

FIG. 1 is a plan view of a carton blank from which a liquid packaging carton is to be made,

FIG. 2 is a diagrammatic side elevation of a heater head for pre-broken, top or bottom end closure sub-panels of the carton, and

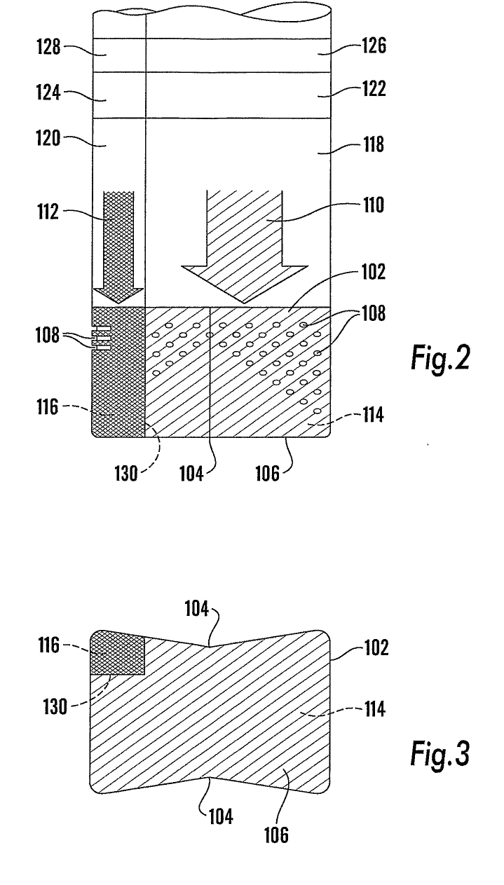

FIG. 3 is a diagrammatic underneath plan view of the heater head.

Referring to FIG. 1, the carton blank consists of a row of panels 2 to 10, known as the first to fifth panels, respectively. Score lines 12 and 14 parallel to the row of panels 2 to 10 divide the panels 2 to 10 into a row of bottom end closure sub-panels 22 to 30 and a row of top end closure sub-panels 32 to 40. A score line 42 parallel to those rows divides the top end closure sub-panels 32 to 40 into a row of top end closure obturating sub-sub-panels 52 to 60 and a row of top end closure sealing sub-sub-panels 62 to 70. The obturating sub-panels 24 and 28 and the obturating sub-sub-panels 54 and 58 are triangularly sub-divided by oblique score lines 72 so that the sub-panels 24 and 28 and the sub-sub-panels 54 and 58 can be folded inwardly upon themselves, with the sub-panels 22 and 26 or the sub-sub-panels 52 and 56 simultaneously being folded thereupon.

Referring to FIGS. 2 and 3, the heater head has a side wall 102 in the form of a closed loop and formed with external indentations 104 for receiving the inwardly pre-broken sub-panels 24 and 28 or sub-sub-panels 54 and 58 of the end closure.

The heater head is closed at its distal end by a wall 106 and is open at its proximal end to receive hot air which is to flow sideways out from the interior of the heater head via holes 108 distributed around the heater head and from which the hot air emanates in the form of hot jets which impinge upon and heat to a tacky consistency the internal plastics surface regions which are to be sealed together to form the end closure. As indicated diagrammatically by the two arrows 110 and 112 in FIG. 2, the hot air is supplied to the interior of the heater head through its open top in two separate streams 110 and 112 which arrive in the heater head through two separate ducts 118 and 120. Each duct has its own air-heating arrangement 122 or 124 which can be controlled, insofar as its temperature is concerned, to at least some extent independently of the air-heating arrangement in the other duct. The two ducts may be supplied with a common air blower, possibly with some means for adjusting relative to each other the rates of air flow through the respective ducts, or the two ducts 118 and 120 may contain respective air blowers 126 and 128 the speeds of which are adjustable relative to each other. In those various ways, it is possible to adjust the temperature and/or flow rates of the air streams 110 and 112. The streams 110 and 112 enter respective separate compartments 114 and 116 of the heater head which are formed by a partition 130 in the interior of the heater head, the compartment 114 occupying most of the interior of the heater head and the compartment 116 occupying that corner of the heater head at which the longitudinal lap seal of the open end zone of the carton sleeve is present. The lower-temperature air stream 110 is indicated by the relatively light hatching in FIGS. 2 and 3, as is the relatively low-temperature volume of the heater head, whilst the higher-temperature stream 112 is indicated by the relatively dense hatching in FIGS. 2 and 3, as is the higher-temperature volume of the heater head. In this manner, the internal plastics surface region at the pre-broken end closure sub-panel 30 or sub-sub-panel 70 can be subjected to a level of heating which ensures blocking of channel leakages thereat, whilst the other sealing regions of the end closure are subjected to a lower temperature, sufficient to render them tacky, but such as to minimise the production of heat cracks and of off-taste.

1-20. (canceled)

21. A method comprising providing a sheet material tube having plastics surface regions which are to be sealed together and are distributed around an open end zone of the tube, heating with a heating medium said plastics surface regions so as to render said regions tacky, the heating being performed in such manner that one surface region of said surface regions is heated to a level higher than are at least some of the others of said regions, and pressing said regions together and thereby sealing said end zone, the temperature of the heating medium impinging on said one surface region being higher than that of the heating medium impinging on said at least some of the others of said regions.

22. A method according to claim 21, wherein said one surface region extends along a longitudinal lap seal of said tube.

23. A method according to claim 21, wherein the heating medium is supplied to a heater head whence the heating medium flows to said regions, and the heating medium for heating said one surface region is supplied as a first stream separate from a second stream of the heating medium for heating said at least some of the others of said regions.

24. A method according to claim 23 and further comprising adjusting the temperature of one of the first and second streams relative to the other.

25. A method according to claim 23 and further comprising adjusting the rate of flow of one of the first and second streams relative to the other.

26. Apparatus for operating upon a sheet material tube having plastics surface regions which are to be sealed together and are distributed around an open end zone of the tube, comprising a heating device so arranged as to emit both a higher-temperature flow of heating medium to impinge upon one surface region of said surface regions and a lower-temperature flow of heating medium to impinge upon at least some of the others of said regions, so that the heating medium heats and thereby renders said regions tacky and said one surface region is heated to a level higher than are said at least some of the others of said regions.

27. Apparatus according to claim 26, wherein said heating device comprises a heater head formed with a plurality of holes through a wall of said head, said wall bounding the interior of said head, said head having an inlet for heating medium which passes from said interior through said holes, and said interior having therein a partition which serves to separate heating medium flowing to some of said holes from heating medium flowing to others of said holes, whereby said one surface region of said surface regions can be heated by heating medium flowing from said some of said holes and said at least some of the others of said regions can be heated by heating medium flowing from said others of said holes.

28. Apparatus according to claim 27, wherein said partition is located in a corner of said interior, from which corner heating medium is to be emitted towards said one surface region which extends along a longitudinal lap seal of said tube.

29. Apparatus according to claim 26, wherein said heating device comprises first and second inlet ducts separate from each other and whereby the heating medium is supplied in first and second separate streams.

30. Apparatus according to claim 29, wherein said heating device includes first and second heating arrangements for the medium in the respective first and second ducts, which heating arrangements can be controlled, insofar as temperature is concerned, to at least some extent independently of each other.

31. Apparatus according to claim 29, wherein said heating device includes a medium blower common to said first and second ducts.

32. Apparatus according to claim 31, wherein said heating device includes means for adjusting relative to each other the rates of medium flow through the respective ducts.

33. Apparatus according to claim 29, wherein said heating device includes first and second medium blowers for the respective first and second ducts, the speed of at least one of said medium blowers being adjustable relative to the other.

34. Apparatus for operating upon a sheet material tube having plastics surface regions which are to be sealed together and are distributed around an open end zone of the tube, comprising a heating device comprised of a heater head formed with a plurality of holes through a wall of said head, said wall bounding the interior of said head, said head having at least one inlet for heating medium which passes from said interior through said holes to heat and thereby render said regions tacky, and said interior having therein a partition which serves to separate heating medium flowing to some of said holes from heating medium flowing to others of said holes, whereby one surface region of said surface regions can be heated to a level higher than are at least some of the others of said regions.

35. Apparatus according to claim 34, wherein said partition is located in a corner of said interior, from which corner heating medium is to be emitted towards said one surface region which extends along a longitudinal lap seal of said tube.

36. Apparatus according to claim 34, wherein said heating device comprises first and second inlet ducts separate from each other and whereby the heating medium is supplied in first and second separate streams.

37. Apparatus according to claim 36, wherein said heating device includes first and second heating arrangements for the medium in the respective first and second ducts, which heating arrangements can be controlled, insofar as temperature is concerned, to at least some extent independently of each other.

38. Apparatus according to claim 36, wherein said heating device includes a medium blower common to said first and second ducts.

39. Apparatus according to claim 38, wherein said heating device includes means for adjusting relative to each other the rates of medium flow through the respective ducts.

40. Apparatus according to claim 36, wherein said heating device includes first and second medium blowers for the respective first and second ducts, the speed of at least one of said medium blowers being adjustable relative to the other.
